(19) United States
(12) Patent Application Publication
(10) Pub. No.: US 2026/0116046 A1
(43) Pub. Date: Apr. 30, 2026

(54) GYPSUM BOARD HAVING OXIDIZED MODIFIED CELLULOSE FIBERS

(71) Applicant: Georgia-Pacific Gypsum LLC, Atlanta, GA (US)

(72) Inventors: Richard David Jordan, Decatur, GA (US); Sudhanshu Srivastava, Decatur, GA (US); Vincent B. Thomas, Bogart, GA (US)

(21) Appl. No.: 19/119,417

(22) PCT Filed: Oct. 31, 2023
(86) PCT No.: PCT/IB2023/060944

§ 371 Date: Apr. 9, 2025

Related U.S. Application Data
(60) Provisional application No. 63/423,820, filed on Nov. 9, 2022.

(51) Int. Cl. B32B 13/02; B32B 5/02; B32B 13/08; B32B 13/14; C04B 11/26; C04B 14/42; C04B 16/02; C04B 16/06; C04B 28/14; C04B 103/60

(52) U.S. Cl. CPC B32B 13/02; B32B 5/022; B32B 13/08; B32B 13/14; C04B 11/26; C04B 14/42; C04B 16/02; C04B 16/0633; C04B 28/14; B32B 2262/0253; B32B 2262/062; B32B 2262/101; B32B 2262/105; B32B 2307/7375; B32B 2607/00; C04B 2103/60

(57) ABSTRACT

Systems and methods for manufacturing a gypsum board having oxidized modified cellulose fibers are provided. A gypsum board includes a gypsum layer formed from a gypsum slurry, where the gypsum layer has a bottom and a top. The gypsum slurry includes oxidized modified cellulose fibers. The gypsum board further includes a first mat placed on the bottom of the gypsum layer, and a second mat placed on the top of the gypsum layer.

### CROSS-REFERENCE TO RELATED APPLICATION

This application claims the benefit of U.S. Provisional Application No. 63/423,820, filed Nov. 9, 2022, and entitled “GYPSUM BOARD HAVING OXIDIZED MODIFIED CELLULOSE FIBERS,” which is incorporated by reference herein in its entirety.

### BACKGROUND

The present invention generally relates to the field of gypsum board products, and more specifically to a gypsum board having oxidized modified cellulose fibers.

Building panels, such as building sheathing or roof panels, include a core material, such as gypsum, and a mat facer, such as a fiberglass mat facer. During manufacturing, the gypsum core material is applied as a slurry to a surface of the mat facer and allowed to set, such that the mat facer and gypsum core are adhered at the interface. Such panels may experience water intrusion and other performance issues.

Through applied effort, ingenuity, and innovation, the Applicants have solved problems related to gypsum board products by developing solutions embodied in the present disclosure, which are described in detail below.

### SUMMARY

According to one embodiment of the present disclosure, a gypsum board having oxidized modified cellulose fibers (OMCF) is provided. The gypsum board includes a gypsum layer formed from a gypsum slurry, where the gypsum layer has a bottom and a top. The gypsum board further includes a first mat placed on the bottom of the gypsum layer, and a second mat placed on the top of the gypsum layer.

In some embodiments, the OMCF includes all carboxylic groups or a combination of aldehydes and acids. In some embodiments, the gypsum slurry further includes fibers other than the OMCF. In some embodiments, the other fibers include organic or inorganic systems such as polypropylene, glass E-type, or ceramic. In some embodiments, the other fibers are larger than the OMCF. In some embodiments, the gypsum slurry further includes polymer additives or polymeric foams. In some embodiments, the polymer additives or polymeric foams include styrene butadiene, polystyrene, polyvinyl alcohol, or acrylate. In some embodiments, electrostatic bonding and mechanical interactions between the OMCF and calcium salt in the gypsum layer of the gypsum board are configured to provide structural integrity to the gypsum board. In some embodiments, the OMCF are added at a rate of between 2 to 20 lbs/msf. In some embodiments, the OMCF are added at a rate of up to 8-9 lbs/msf. In some embodiments, the OMCF form a ring open structure. In some embodiments, the gypsum board further includes a slate coat having the OMCF. In some embodiments, the OMCF are added as a dry additive with gypsum stucco. In some embodiments, the OMCF are added as a liquid additive or slurry with gypsum stucco. In some embodiments, the OMCF include a debonder for ease of hydro pulping. In some embodiments, the first mat or the second mat includes a nonwoven fiberglass mat or a paper facer. In some embodiments, the first mat or the second mat includes a mat coating opposite a side of the first or second mat that faces the gypsum layer. In some embodiments, the OMCF are configured to create a low pH localized environment that slows biologic growth on or in the gypsum board. In some embodiments, the OMCF are configured to slow the growth of mold or mildew on or in the gypsum board. In some embodiments, the OMCF includes a liquid pulp of OMCF.

According to yet another embodiment of the present disclosure, a method of manufacturing a gypsum board having oxidized modified cellulose fibers is provided. The method includes preparing oxidized modified cellulose fibers and forming a gypsum layer from a gypsum slurry. The gypsum layer has a bottom and a top, and the gypsum slurry contains the oxidized modified cellulose fibers. The method further includes positioning a first mat on the bottom of the gypsum layer and positioning a second mat on the top of the gypsum layer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a cross-sectional view of an example gypsum panel, according to various embodiments;

FIG. 2 is a cross-sectional view of an example gypsum panel, according to various embodiments;

FIG. 3 depicts example structure and calcium salt reactions of oxidized modified cellulose fibers, according to various embodiments;

FIG. 4 is a chart depicting comparison of cube compression testing results associated with example oxidized modified cellulose fibers, according to various embodiments;

FIGS. 5A, 5B, and 5C are charts depicting pull through, humid bond, and compression test results based on gypsum cores incorporating oxidized modified cellulose fibers, according to various embodiments; and

FIG. 6 depicts example liquid pulp of oxidized modified cellulose fibers, for use with various embodiments.

### DETAILED DESCRIPTION

The invention is described in detail below with reference to the figures for purposes of illustration only. Modification to various embodiments illustrated within the spirit and scope of the present invention will be readily apparent to one of skill in the art.

Embodiments herein provide for strength and reinforcement to gypsum boards (also referred to herein as gypsum panels) by incorporating oxidized modified cellulose fibers (OMCF). Various examples of modified cellulose fibers are described in U.S. Pat. No. 8,778,136, which is incorporated herein. The use of non-modified cellulose fibers in gypsum boards under the right conditions may lead to mold and mildew growth. While applications may attempt to incorporate cellulose fibers to gypsum boards, the addition of a biocide is the only way to truly counteract mold and mildew growth. Embodiments herein overcome such drawbacks and more by oxidizing or partially oxidizing the cellulose fibers to the point of modifying the structure of the cellulose fibers to they are not susceptible to mold and mildew growth. Embodiments herein further enable weight reduction without any negative impact on strength properties of the gypsum board or panel.

Embodiments herein provide structural integrity to gypsum boards as a result of chemical (e.g., electrostatic bonding) and mechanical interactions between the modified cellulose fibers and calcium salt in the gypsum core of the gypsum board. In some embodiments, the modified cellulose fibers can be added up to 9 lbs/msf. In some embodiments, the modified cellulose fibers can be added between 2 to 20 lbs/msf alone, or in combination with other fiber systems, polymer additives or polymeric foams. In certain instances, the rate of addition of the modified cellulose fibers may be between 10 and 15 lbs/msf; in other embodiments, the rate of addition may extend above 20 lbs/msf, for example up to 30 lbs/msf. Fibers can include organic or inorganic systems such as polypropylene, glass E-type, ceramic, or the like. Polymers or Polyfoam can include styrene butadiene, polystyrene, polyvinyl alcohol, acrylate, styrene-acrylic copolymer, or the like.

Generating the oxidized modified cellulose fibers can include different levels of oxidation and ring-opening. In some embodiments, the oxidized cellulose may have all carboxylic groups or a combination of aldehydes and acids. Due to oxidation, the cellulose fibers are also 25% smaller in size and have better flow rates (e.g., as opposed to non-oxidized cellulose fibers). In certain instances, the cellulose fibers may be in a range of approximately 15% to 35% smaller in size; in other embodiments, the range may be between 20% and 30%. In some embodiments, the OMCF range in length from 0.1 microns to 3 millimeters, 1 microns to 2 millimeters, or 100 microns to 1 millimeter.

In various embodiments, a gypsum core for a gypsum board includes a gypsum slurry and oxidized modified cellulose fibers (e.g., 2 to 20 lbs/msf).

In various embodiments, a gypsum core for a gypsum board includes a gypsum slurry with a PVA polymer foam and oxidized modified cellulose fibers (e.g., 2 to 20 lbs/msf).

In various embodiments, a gypsum core for a gypsum board includes a gypsum slurry with a styrene butadiene polymer foam and oxidized modified cellulose fibers (e.g., 2 to 20 lbs/msf).

In various embodiments, a gypsum core for a gypsum board includes a gypsum slurry with a PVA polymer foam, oxidized modified cellulose fibers (e.g., 2 to 20 lbs/msf), and polypropylene fibers.

In various embodiments, a gypsum core for a gypsum board includes a gypsum slurry with a styrene butadiene polymer foam, oxidized modified cellulose fibers (e.g., 2 to 20 lbs/msf), and polypropylene fibers.

In various embodiments, oxidized modified cellulose fibers are added only to a slate coat of a gypsum board. In various embodiments, oxidized modified cellulose fibers are added the gypsum core as well as slate coat of a gypsum board. In various embodiments, oxidized modified cellulose fibers are added as a dry additive with gypsum stucco. In various embodiments, oxidized modified cellulose fibers are added as a slurry from a hydro pulping process to gypsum stucco.

Gypsum panels or boards may contain a set gypsum core sandwiched between two mats, one or both of which may be coated. The mat coating may be a substantially continuous barrier coating. As used herein, the term “substantially continuous barrier coating” refers to a coating material that is substantially uninterrupted over the surface of the mat.

During manufacturing, a gypsum slurry may be deposited on the uncoated surface of a facer material, such as a paper sheet or fiberglass mat (which may be pre-coated offline or online) and set to form a gypsum core of the panel. The gypsum slurry may penetrate some portion of the thickness of the fiberglass mat or adhere to a paper facing material and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

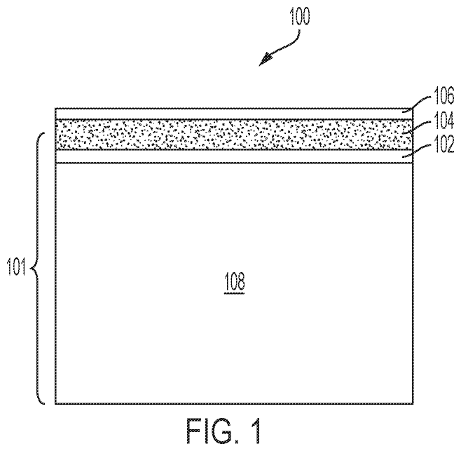

In certain embodiments, as shown in FIG. 1, a gypsum panel 100 includes a gypsum core 101 having a first surface and a second opposed surface, and a first facer material 104 (shown here as a fibrous mat) associated with the first surface of the gypsum core 101, such that gypsum of the gypsum core penetrates at least a portion of the first mat 104. The various layers are illustrated as separate layers in the figures for ease of illustration; however, it should be understood that overlap of these materials may occur at their interfaces. In certain embodiments, the gypsum panel 100 includes a set gypsum core 101 associated with a first surface of first fibrous mat 104 and an optional mat coating 106 applied to a second surface of the first fibrous mat 104.

In some embodiments, as shown in FIG. 1, the gypsum of the gypsum core 101 penetrates a remaining portion of the first fibrous mat 104 such that voids in the mat 104 are substantially eliminated and the water resistance of the panel 100 is further enhanced. For example, in one embodiment, the first mat 104 has a mat coating 106 on a surface opposite the gypsum core 101, the mat coating 106 penetrating a portion of the first mat 104, to define the remaining portion of the first mat 104. That is, gypsum of the gypsum core 101 may penetrate a remaining fibrous portion of the first fibrous mat 104 such that voids in the first mat 104 are substantially eliminated. In certain embodiments, the mat 104 is a nonwoven fiberglass mat or a paper facer. In some embodiments, additional components such as starch may be added to the gypsum panel 100.

In certain embodiments, as shown in FIG. 1, the gypsum core 101 includes two or more gypsum layers 102, 108. For example, the gypsum core may include various gypsum layers having different compositions.

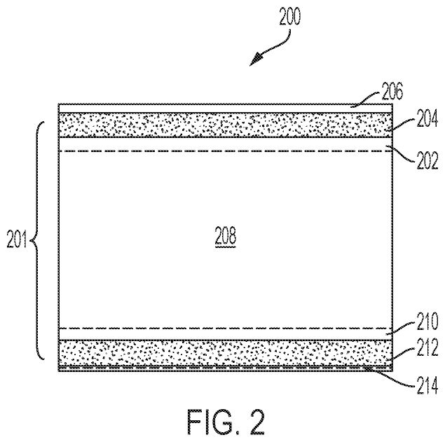

In certain embodiments, as shown in FIG. 2, a gypsum panel 200 includes two fibrous mats 204, 212 that are associated with the gypsum core 201. The second mat 212 is present on a face of the gypsum core 201 opposite the first mat 204. In some embodiments, only the first mat 204 has a mat coating 206 on a surface thereof. In other embodiments, both mats 204, 212 have a coating 206, 214 on a surface thereof opposite the gypsum core 201. In some embodiments, the gypsum core 201 includes three gypsum layers 202, 208, 210.

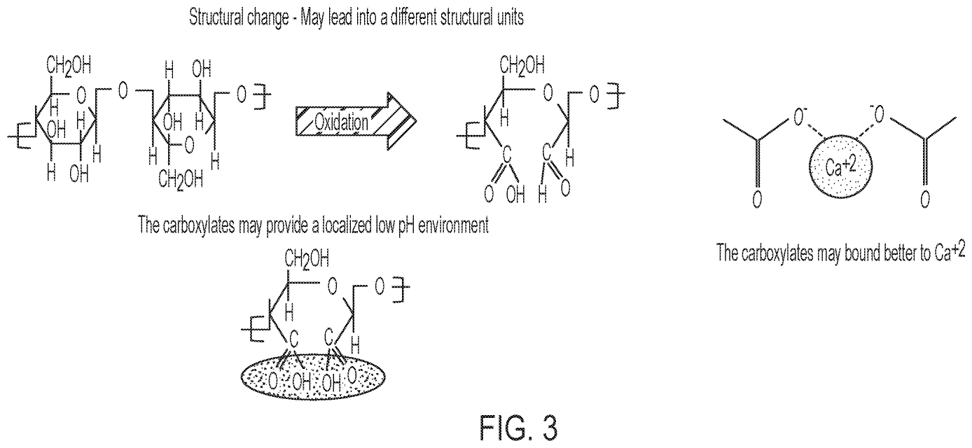

FIG. 3 depicts example structure and calcium salt reactions of oxidized modified cellulose fibers, according to various embodiments. Shown in FIG. 3, oxidized carboxylates are formed with a ring open structure. These oxidized carboxylates are structurally and chemically different from natural cellulose fibers.

### EXAMPLES

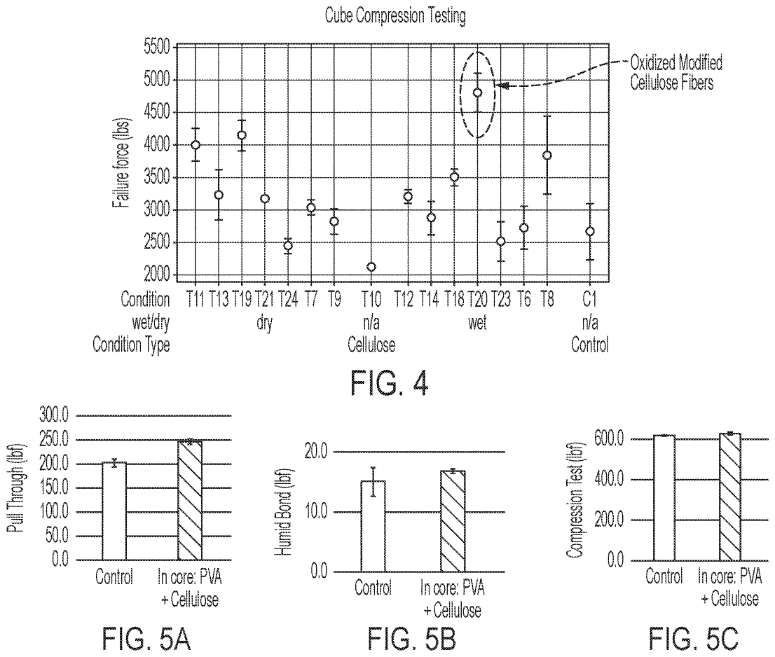

### Example 1—Cube Compression Tests (Data Presented in FIG. 4)

FIG. 4 is a chart depicting comparison of cube compression testing results associated with example oxidized modified cellulose fibers, according to various embodiments. For the results in FIG. 4, a gypsum slurry was prepared by combining stucco with water and other formulation components with the fibers under dry and wet conditions at 7-9 lbs/msf. The slurry was then poured in a mold and dried in an oven to remove any extra moisture. The dried sample was then analyzed to estimate the cube strength. As shown in FIG. 4, sample gypsum boards having oxidized modified cellulose fibers outperformed in cube compression testing and provided the best strength as compared to other cellulose-based systems.

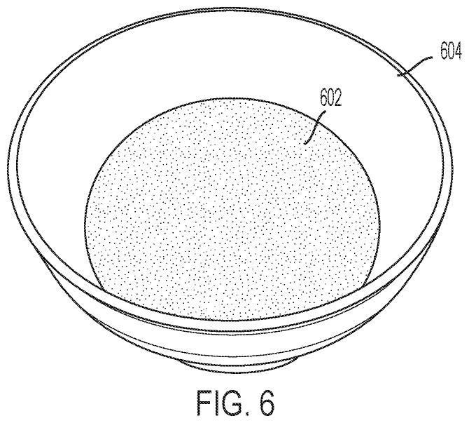

### Example 2—Pull Through Tests (Data Presented in FIG. 5A)

FIG. 5A depicts pull through results based on gypsum cores incorporating oxidized modified cellulose fibers, according to various embodiments. For the results in FIG. 5A, gypsum board was prepared by combining stucco with water and other formulation components as control sample. Similarly, another formulation was prepared for testing, having the same stucco:water ratio, other formulation components with oxidized modified cellulose fibers (˜8 lbs/msf), and PVA foam to reduce the board weight by ˜20% compared to control sample.

A fastener was then inserted through each sample board, where the fastener holds a metallic disk on one side and the fastener is connected to an upper jaw of the testing machine on the other end. It is then confirmed that the clamp is aligned at a right angle to a square steel cradle holding the sample board. Once the board is confirmed to be properly fixed position, using the testing machine, the fastener is pulled up through the sample board. For each sample board and every test, the peak load and mode of failure is recorded. Strength was improved for the sample with oxidized modified cellulose fibers, as compared to the control sample.

### Example 3—Humid Bond Tests (Data Presented in FIG. 5B)

FIG. 5B depicts humid bond results based on gypsum cores incorporating oxidized modified cellulose fibers, according to various embodiments. The humid bond test determines the bond strength between the glass mat and the gypsum core of a gypsum board. For the results in FIG. 5B, a gypsum slurry was prepared by combining stucco with water and other formulation components as control sample. Similarly, another formulation was prepared for testing having the same stucco:water ratio, other formulation components with oxidized modified cellulose fibers (˜8 lbs/msf), and PVA foam to reduce the board weight by ˜20% compared to control sample. Samples with oxidized modified cellulose fibers performed better than or equal to the control sample.

### Example 4—Compression Tests (Data Presented in FIG. 5C)

FIG. 5C depicts compression test results based on gypsum cores incorporating oxidized modified cellulose fibers, according to various embodiments. For the results shown in FIG. 5C, a gypsum slurry was prepared by combining stucco with water and other formulation components as a control sample. The slurry was then poured in a mold and dried in an oven to remove any extra moisture. The dried sample was then analyzed to estimate the cube strength of samples. Similarly, another formulation was prepared for testing, having the same stucco:water ratio, other formulation components with oxidized modified cellulose fibers (˜10 lbs/msf), and PVA foam to reduce the weight and compare with control sample. The sample with oxidized modified cellulose fibers delivered better than or equal performance to the control samples.

That is, as shown in FIGS. 5A, 5B, and 5C, sample gypsum boards having oxidized modified cellulose fibers (as well as PVA in the gypsum core) outperformed in each of pull through testing, humid bond testing, and compression testing as compared to a gypsum board without oxidized modified cellulose fibers and PVA in the gypsum core. Further, sample gypsum boards having oxidized modified cellulose fibers (as well as PVA in the gypsum core) enabled weight reduction for the gypsum boards.

FIG. 6 depicts example liquid pulp of oxidized modified cellulose fibers 602 stored in a container bowl 604, for use with various embodiments. The liquid pulp of oxidized modified cellulose fibers 602 can be used for manufacturing of embodiments described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A gypsum board, comprising:
a gypsum layer formed from a gypsum slurry, the gypsum layer having a bottom and a top, wherein the gypsum slurry comprises oxidized modified cellulose fibers (OMCF);
a first mat placed on the bottom of the gypsum layer; and
a second mat placed on the top of the gypsum layer.

2. The gypsum board of claim 1, wherein the OMCF comprise all carboxylic groups or a combination of aldehydes and acids.

3. The gypsum board of claim 1, wherein the gypsum slurry further comprises fibers other than the OMCF.

4. The gypsum board of claim 3, wherein the other fibers comprise organic or inorganic systems such as polypropylene, glass E-type, or ceramic.

5. The gypsum board of claim 4, wherein the other fibers are larger than the OMCF, and wherein the OMCF range in length from 0.1 microns to 3 millimeters, 1 microns to 2 millimeters, or 100 microns to 1 millimeter.

6. The gypsum board of claim 1, wherein the gypsum slurry further comprises polymer additives or polymeric foams.

7. The gypsum board of claim 6, wherein the polymer additives or polymeric foams comprise styrene butadiene, polystyrene, polyvinyl alcohol, or acrylate.

8. The gypsum board of claim 1, wherein electrostatic bonding and mechanical interactions between the OMCF and calcium salt in the gypsum layer of the gypsum board are configured to provide structural integrity to the gypsum board.

9. The gypsum board of claim 1, wherein the OMCF are added at a rate of up to 9 lbs/msf.

10. The gypsum board of claim 1, wherein the OMCF form a ring open structure.

11. The gypsum board of claim 1, further comprising a slate coat comprising the OMCF.

12. The gypsum board of claim 1, wherein the OMCF are added as a dry additive with gypsum stucco.

13. The gypsum board of claim 1, wherein the OMCF are added as a liquid additive or slurry with gypsum stucco.

14. The gypsum board of claim 1, wherein the OMCF comprise a debonder for ease of hydro pulping.

15. The gypsum board of claim 1, wherein the first mat or the second mat comprises a nonwoven fiberglass mat or a paper facer.

16. The gypsum board of claim 1, wherein the first mat or the second mat comprises a mat coating opposite a side of the first or second mat that faces the gypsum layer.

17. The gypsum board of claim 1, wherein the OMCF are configured to create a low pH localized environment that slows biologic growth on or in the gypsum board.

18. The gypsum board of claim 1, wherein the OMCF are configured to slow the growth of mold or mildew on or in the gypsum board.

19. The gypsum board of claim 1, wherein the OMCF comprises a liquid pulp of OMCF.

20. A method for manufacturing a gypsum board, the method comprising:
preparing oxidized modified cellulose fibers (OMCF);
forming a gypsum layer from a gypsum slurry, the gypsum layer having a bottom and a top, the gypsum slurry containing the OMCF;
positioning a first mat on the bottom of the gypsum layer; and
positioning a second mat on the top of the gypsum layer.
